(19) United States
(12) Patent Application Publication
(10) Pub. No.: US 2013/0082983 A1
(43) Pub. Date: Apr. 4, 2013

(54) MULTI-POINTER FOR TOUCHSCREEN STYLUS

(71) Applicants: CHIN-MIN LIU, HSINCHU COUNTY (TW); HSUEH-CHIH LIU, HSINCHU COUNTY (TW)

(72) Inventors: CHIN-MIN LIU, HSINCHU COUNTY (TW); HSUEH-CHIH LIU, HSINCHU COUNTY (TW)

(21) Appl. No.: 13/252,266

(22) Filed: Oct. 4, 2011

(51) Int. Cl. G06F 3/033

(52) U.S. Cl. 345/179

(57) ABSTRACT

The present invention discloses a multi-pointer touchscreen stylus, which comprises a shaft having at least two pointers at the front end thereof. The present invention can present personal calligraphy according to one's handwriting. The present invention can also present a stroke with varying widths according to varying strengths of writing action, whereby the user may write on a touchscreen with more pleasure. Further, the present invention can prevent a touchscreen from being stained or scratched.

### BACKGROUND OF THE INVENTION

1. Field of the Invention

The present invention relates to a touchscreen stylus, particularly to a multi-pointer touchscreen stylus able to present one's calligraphy.

2. Description of the Related Art

It is convenient to operate a touchscreen with one's finger. However, the finger is easy to sweat and likely to leave stains on the touchscreen. Therefore, a touchscreen is usually operated with a stylus. The touchscreen styluses may be categorized into the resistive touchscreen stylus and the capacitive touchscreen stylus. In a resistive touchscreen, an upper ITO (Indium Tin Oxide) controller and a lower ITO controller are used to detect the voltage variation of the touchscreen, whereby to determine the coordinates of the contacted point. Therefore, the resistive touchscreen stylus is simply a pen-like object used to press a resistive touchscreen. In a capacitive touchscreen, the human body's static electricity induces the capacitance variation of the arrayed transparent electrodes, and the capacitance variation is used to determine the coordinates of the contacted point.

Refer to FIG. 1. A conventional capacitive touchscreen stylus comprises a shaft 10. The shaft 10 has an inductor 14 electrically connected with a pointer 12. When the pointer 12 scribes a capacitive touchscreen, the capacitance varies. As the conventional capacitive touchscreen stylus has only a single pointer 12 to scribe on the touchscreen, the strengths and features of one's handwriting are unlikely to present.

Accordingly, the present invention proposes a multi-pointer touchscreen stylus to overcome the abovementioned problem.

### SUMMARY OF THE INVENTION

The primary objective of the present invention is to provide a multi-pointer touchscreen stylus, which can present the features of one's handwriting according to the strengths of one's writing actions.

Another objective of the present invention is to provide a multi-pointer touchscreen stylus, whereby to prevent the touchscreen from being stained by sweat or being scratched by a stylus or finger.

A further objective of the present invention is to provide a multi-pointer touchscreen stylus, which can function like a brush pen to present Chinese calligraphy on the touchscreen.

To achieve the abovementioned objectives, the present invention proposes a multi-pointer touchscreen stylus, which comprises a shaft having at least two pointers at the front end thereof.

Below, the embodiments are described in detail in cooperation with the attached drawings to make easily understood the structural features and efficacies of the present invention.

### BRIEF DESCRIPTION OF THE DRAWINGS

FIG. 1 shows a conventional capacitive touchscreen stylus;

FIG. 2 is a perspective view schematically showing a multi-pointer touchscreen stylus with spherical pointers according to one embodiment of the present invention;

FIG. 3 is a perspective view schematically showing a multi-pointer touchscreen stylus with columnar pointers according to one embodiment of the present invention;

FIG. 4a and FIG. 4b are two perspective views respectively schematically showing two multi-pointer touchscreen styluses with brush-pen tip pointers according to embodiments of the present invention;

FIG. 5a and FIG. 5b are two perspective views respectively schematically showing two multi-pointer touchscreen styluses with a nib-like front end according to embodiments of the present invention;

FIGS. 6a-6e schematically show the lines drawn with a multi-pointer touchscreen stylus with spherical pointers according to one embodiment of the present invention;

FIGS. 7a-7d schematically show the lines drawn with a multi-pointer touchscreen stylus with brush-pen tip pointers according to one embodiment of the present invention; and

FIGS. 8a-8b schematically show the lines drawn with a multi-pointer touchscreen stylus with a nib-like front end according to one embodiment of the present invention.

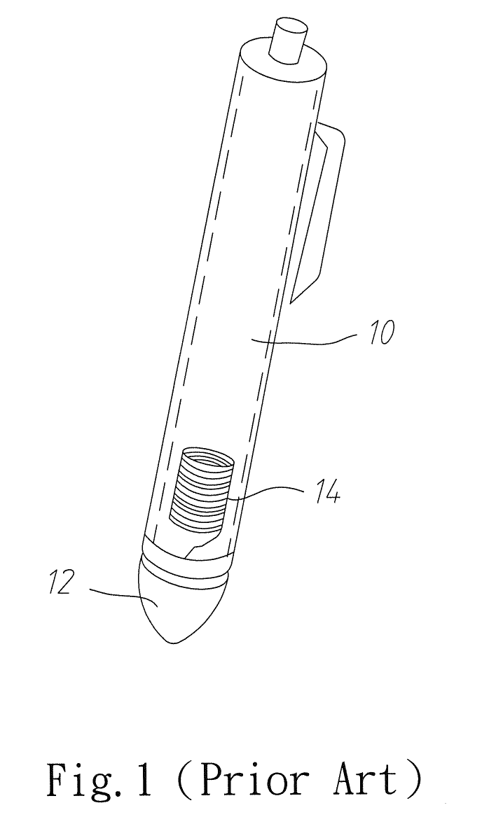

### DETAILED DESCRIPTION OF THE INVENTION

The present invention discloses a multi-pointer touchscreen stylus, which applies to a resistive or capacitive touchscreen, and which can present the features of personal calligraphy.

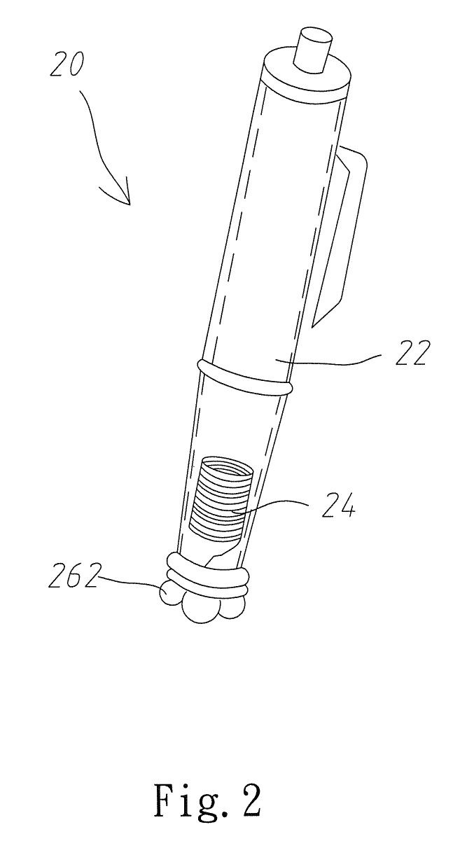

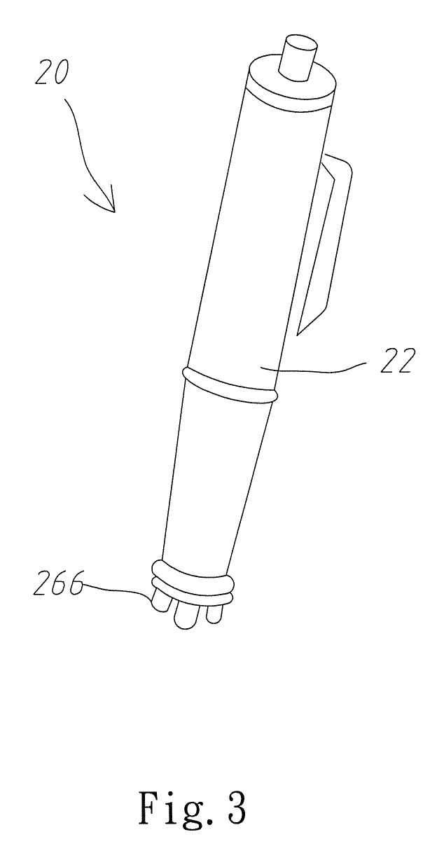

Refer to FIG. 2 a perspective view schematically showing a multi-pointer touchscreen stylus with spherical pointers according to one embodiment of the present invention. The multi-pointer touchscreen stylus 20 of the present invention comprises a shaft 22. The front end of the shaft 22 electrically connects with at least two spherical pointers 262. In one embodiment, the multi-pointer touchscreen stylus further comprises an inductor 24. The inductor 24 enables the multi-pointer touchscreen stylus 20 to apply to a capacitive touchscreen. When the multi-pointer touchscreen stylus 20 scribes on a capacitive touchscreen, the inductor 24 increases the magnitude of capacitance variation and makes the multi-pointer touchscreen stylus 20 operate the capacitive touchscreen more sensitively. When the multi-pointer touchscreen stylus 20 applies to capacitive touchscreens or resistive touchscreens, the spherical pointers 262 are made of a flexible conductive material, such as a conductive sponge or a conductive rubber. When the multi-pointer touchscreen stylus 20 only applies to resistive touchscreens, the spherical pointers 262 may be made of a non-conductive material. The spherical pointers 262 can be assembled to the shaft 22 via press-fitting, iron ring fixing, or gluing. In one embodiment, the spherical pointers 262 are detachable from the shaft 22 and can be replaced by different types of pointers. In the embodiment shown in FIG. 2, there are three spherical pointers 262. However, the present invention does not constrain that the multi-pointer touchscreen stylus 20 should have three spherical pointers 262. In other embodiments, the multi-pointer touchscreen stylus 20 may have two, four, five, six, or more spherical pointers 262. In the present invention, the central spherical pointer 262 should be more protrudent than the peripheral spherical pointers 262 so as to form a stepped profile. When the user applies less force to operate the multi-pointer touchscreen stylus 20, only the central spherical pointers 262 can contact the touchscreen. When the user applies more force to operate the multi-pointer touchscreen stylus 20, the peripheral spherical pointers 262 can also contact the touchscreen. Thereby, the touchscreen can recognize and present different strengths of operating the multi-pointer touchscreen stylus 20. Refer to FIG. 3. In one embodiment, the pointers 262 are in form of columnar pointers 266. The structure and operation of the columnar pointers 266 is similar to that of the spherical pointers 262 and will not repeat herein.

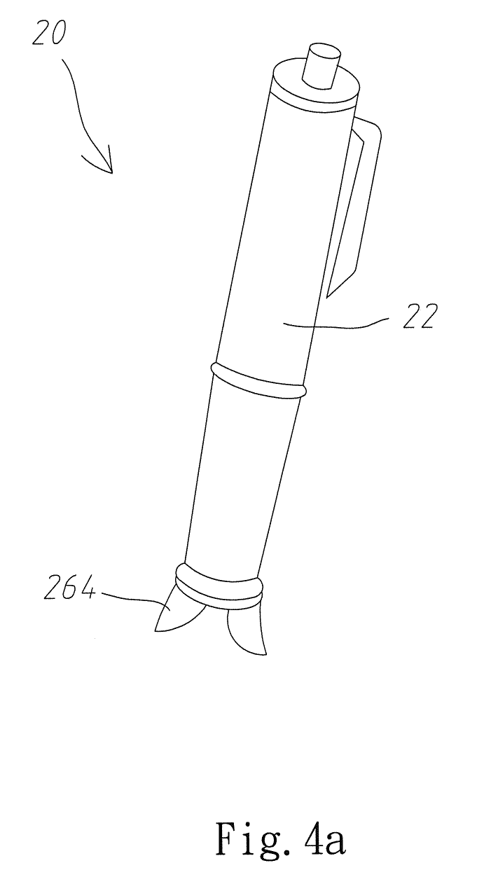

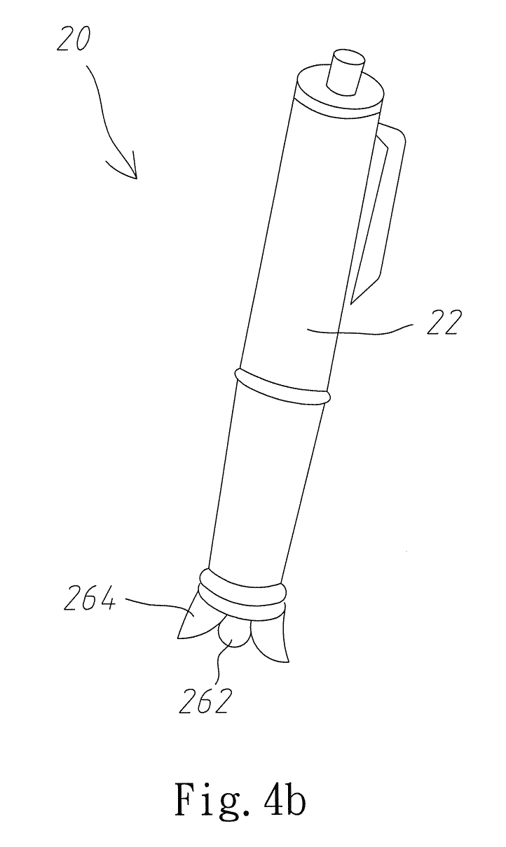

Refer to FIG. 4a a perspective view schematically showing a multi-pointer touchscreen stylus with brush-pen tip pointers according to one embodiment of the present invention. As shown in FIG. 4a, the multi-pointer touchscreen stylus 20 has two brush-pen tip pointers 264. Distinct from the spherical pointers 262 having a stepped profile, the two brush-pen tip pointers 264 have an identical length. Refer to FIG. 4b. In one embodiment, a spherical pointer 262 is added to the center of the two brush-pen tip pointers 264. In one embodiment, the spherical pointer 262 at the center of the two brush-pen tip pointers 264 is replaced by a columnar pointer.

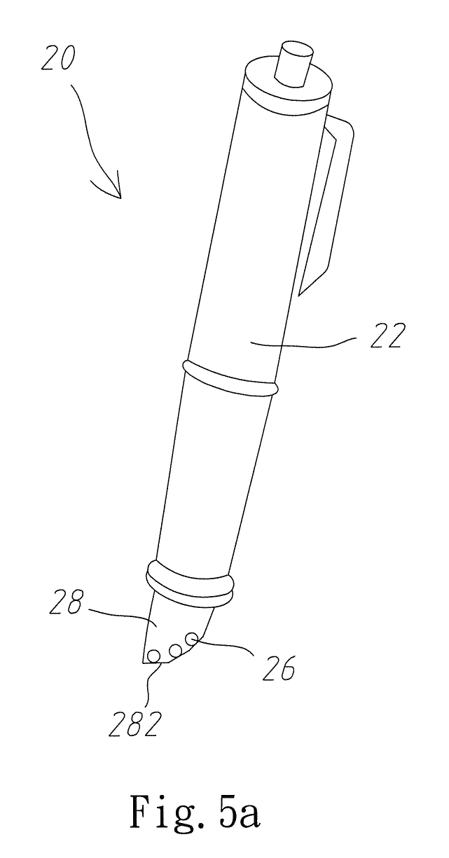

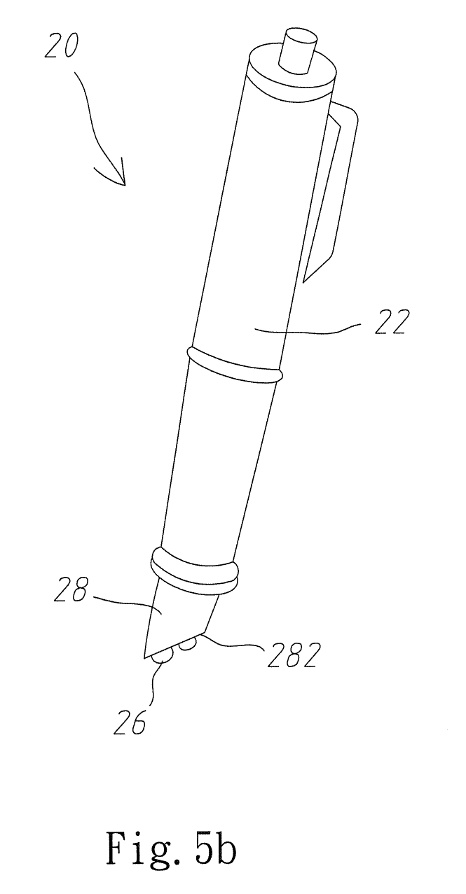

Refer to FIG. 5a. In one embodiment, the end of the multi-pointer touchscreen stylus 20 is in form of a nib 28. The nib 28 has an inclined region 282. The inclined region 282 includes a plurality of inclined planes respectively having different inclined angles. Each inclined plane has a pointer 26. All the pointers 26 and the nib 28 are fabricated into a one-piece component. When the multi-pointer touchscreen stylus 20 applies to capacitive touchscreens or resistive touchscreens, the nib 28 is made of a flexible conductive material, such as a conductive sponge or a conductive rubber. When the multi-pointer touchscreen stylus 20 only applies to resistive touchscreens, the nib 28 may be made of a non-conductive material. The nib 28 can be assembled to the shaft 22 via press-fitting, iron ring fixing, or gluing. In one embodiment, the nib 28 is detachable from the shaft 22 and can be replaced by different types of nibs. Refer to FIG. 5b. In one embodiment, each inclined plane has at least two pointers 26, and one pointer 26 is more protruding than the other one. Thereby, applying different strengths generates different calligraphy.

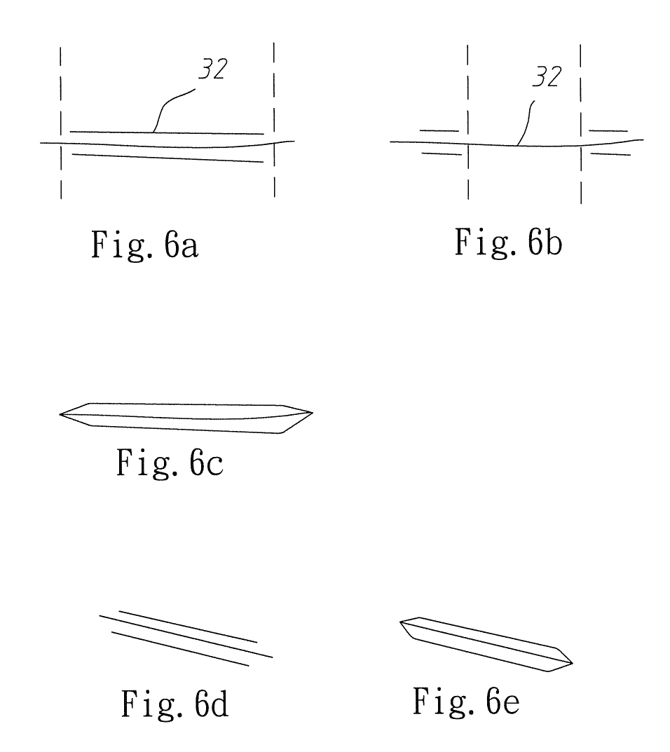

In the present invention, different types of pointers generate different textures of calligraphy. For an example, the multi-pointer touchscreen stylus 20 having three spherical pointers 262 (shown in FIG. 2) is used to scribe on a touchscreen. When greater force is applied to the multi-pointer touchscreen stylus 20, the peripheral spherical pointers 262 contact the touchscreen. Thus, applying greater force to the multi-pointer touchscreen stylus 20 in drawing the middle sections 32 of the lines will generates the lines shown in FIG. 6a; applying smaller force to the multi-pointer touchscreen stylus 20 in drawing the middle sections of the lines will generates the line shown in FIG. 6b. If software is used to combine the lines shown in FIG. 6a, the calligraphy shown in FIG. 6c is obtained. Suppose that the multi-pointer touchscreen stylus 20 generates the lines shown in FIG. 6d. The software will combine the lines shown in FIG. 6d into the calligraphy shown in FIG. 6e. Therefore, the multi-pointer touchscreen stylus 20 of the present invention can generate personal calligraphies according to personal writing actions.

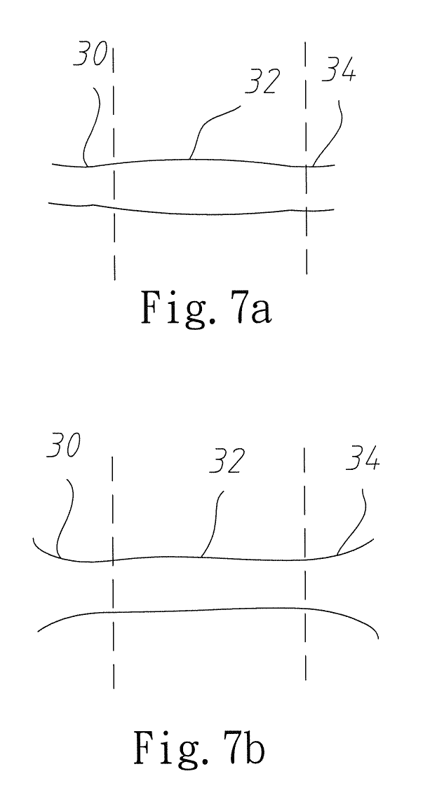

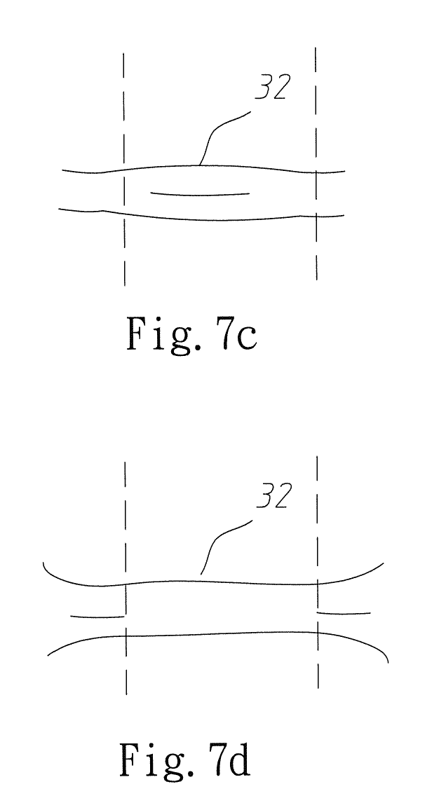

For another example, the multi-pointer touchscreen stylus 20 having brush-pen tip pointers 264 (shown in FIG. 4a) is used to scribe on a touchscreen. As the brush-pen tip pointers 264 are made of a flexible material, applying greater force bends the brush-pen tip pointers 264 and inflects the lines being drawn. Thus, the lines shown in FIG. 7a are obtained. When greater force is applied to the multi-pointer touchscreen stylus 20 in the middle sections 32 of the lines, the brush-pen tip pointers 264 bends, and the drawn lines have inflected middle sections 32, as shown in FIG. 7a. When the front sections 30 and the rear sections 34 are scribed with greater force than the middle sections 32, the front sections 30 and the rear sections 34 are inflected, as shown in FIG. 7b. For yet another example, the multi-pointer touchscreen stylus 20 having two brush-pen tip pointers 264 and one spherical pointer 262 (shown in FIG. 4b) is used to scribe on a touchscreen. As the brush-pen tip pointers 264 are more protruding than the spherical pointer 262, the spherical pointer 262 does not contact the touchscreen unless greater force is applied. When greater force is applied in drawing the middle sections 32, the lines shown in FIG. 7c is obtained. When smaller force is applied in drawing the middle sections 32, the lines shown in FIG. 7d is obtained.

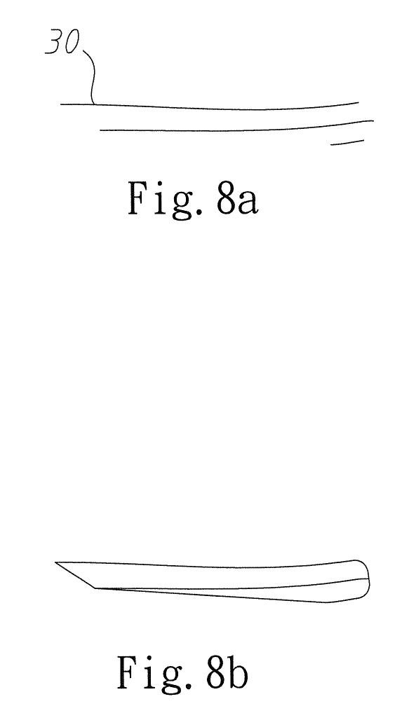

For a further example, the multi-pointer touchscreen stylus 20 having one nib 28 and several pointers 26 fabricated into a one-piece component (shown in FIG. 5a) is used to scribe on a touchscreen. In the example, the applied force is smaller in drawing the front section 30 at beginning, and then the applied force is gradually increased, whereby the touchscreen is scribed by more and more pointers 26 on the inclined region 282 to present the lines shown in FIG. 8a. If software is used to combine the lines in FIG. 8a, the calligraphy shown in FIG. 8b is obtained. The calligraphy in FIG. 8b resembles that generated by a brush pen. Therefore, the user may use the multi-pointer touchscreen stylus 20 and a touchscreen to excise calligraphy, neither wasting paper nor consuming ink. The operation of the multi-pointer touchscreen stylus 20 shown in FIG. 5b is similar to that of the multi-pointer touchscreen stylus 20 with spherical pointers 262 and will not repeat herein.

In conclusion, the present invention can prevent a touchscreen from being stained by dirt and sweat and from being scratched by improper operation. Further, the present invention can present personal calligraphy according to personal writing action. Thus, handwriting on a touchscreen becomes more vivid. Besides, the multi-pointer touchscreen stylus of the present invention is applicable to various resistive and capacitive touchscreens.

The embodiments described above are only to exemplify the present invention but not to limit the scope of the present invention. Any equivalent modification or variation according to the spirit of the present invention is to be also included within the scope of the present invention.

What is claimed is:

1. A multi-pointer touchscreen stylus comprising
a shaft; and
at least two pointers arranged at a front end of said shaft.

2. The multi-pointer touchscreen stylus according to claim 1, wherein said pointers are brush-pen tip pointers.

3. The multi-pointer touchscreen stylus according to claim 1, wherein said pointers are spherical pointers.

4. The multi-pointer touchscreen stylus according to claim 2, wherein a spherical pointer is arranged in a region among at least two said brush-pen tip pointers.

5. The multi-pointer touchscreen stylus according to claim 3, wherein one said spherical pointer is arranged in a region among at least two said spherical pointers and more protruding from said spherical pointers arranged at periphery.

6. The multi-pointer touchscreen stylus according to claim 1, which is applicable to resistive touchscreens and capacitive touchscreens.

7. The multi-pointer touchscreen stylus according to claim 1 further comprising a nib having at least one inclined region, wherein at least two pointers are arranged in said inclined region, and wherein said nib is arranged at a front end of said shaft.

8. The multi-pointer touchscreen stylus according to claim 7, wherein said inclined region contains a plurality of inclined planes respectively having different inclined angles, and wherein each said inclined plane has one said pointer.

9. The multi-pointer touchscreen stylus according to claim 7, wherein said nib and said pointers are fabricated into a one-piece component.

10. The multi-pointer touchscreen stylus according to claim 2, wherein said brush-pen tip pointers are detachable from said shaft.

11. The multi-pointer touchscreen stylus according to claim 3, wherein said spherical pointers are detachable from said shaft.

12. The multi-pointer touchscreen stylus according to claim 7, wherein said nib are detachable from said shaft.

13. The multi-pointer touchscreen stylus according to claim 7, wherein said nib or said pointers are made of a flexible conductive material.

14. The multi-pointer touchscreen stylus according to claim 1, wherein said spherical pointers are replaced by columnar pointers.

15. The multi-pointer touchscreen stylus according to claim 4, wherein said spherical pointers are replaced by columnar pointers.

16. The multi-pointer touchscreen stylus according to claim 5, wherein said spherical pointers are replaced by columnar pointers.
